(19) United States
(12) Patent Application Publication
(10) Pub. No.: US 2020/0055248 A1
(43) Pub. Date: Feb. 20, 2020

(54) METHOD AND CONTAINER FOR REMOVING RESIN RESIDUES FROM A MODEL CREATED BY THREE-DIMENSIONAL 3D PRINTING

(71) Applicant: DWS s.r.l., Thiene (VI) (IT)

(72) Inventor: Maurizio COSTABEBER, Zanè (VI) (IT)

(73) Assignee: DWS s.r.l., Thiene (VI) (IT)

(21) Appl. No.: 16/487,171

(22) PCT Filed: Feb. 23, 2018
(86) PCT No.: PCT/IB2018/051138

§ 371 Date: Aug. 20, 2019

(30) Foreign Application Priority Data
Feb. 23, 2017 (IT) 102017000020797

(51) Int. Cl. B29C 64/35; B33Y 10/00; B33Y 40/00; B29C 64/135; B08B 3/04; B08B 3/08

(52) U.S. Cl. CPC B29C 64/35; B33Y 10/00; B33Y 40/00; B29L 2031/7536; B08B 3/044; B08B 3/08; B29C 64/135

(57) ABSTRACT

Method for removing resin residues from a model created by three-dimensional 3D printing, including the steps of creating a three-dimensional model through three-dimensional 3D printing, inserting the model into a container (10), introducing a solvent (24) into the container (10) and moving the container (10) with the solvent (24) and the model by means of repeated linear movements. The application further relates to a container (10) for removing resin residues from a model created through three-dimensional 3D printing, the container (10) including a tank (20) adapted to contain a solvent (24), a cover (30) adapted to close the tank (20) and means (38) for sealing the cover (30) to the tank (20), wherein the cover (30) includes or is a base (32) of three-dimensional 3D printer, the base (32) including one or more anchoring elements (34) for a three-dimensional model.

The present invention relates to a method for removing resin residues from a model created by three-dimensional 3D printing.

The present invention further relates to a container for removing resin residues from a model created by three-dimensional 3D printing.

In the present description and in the following claims, the terms “three-dimensional 3D printing” and “three-dimensional 3D printer” refer to the technology that creates three-dimensional objects by means of a plurality of superposed layers, in which each layer is obtained by selective solidification of a fluid substance in the areas corresponding to the volume of the object to be produced.

In particular, in the present description and in the following claims, three-dimensional 3D printing can be a stereolithography, for example a laser scanning stereolithography or of a commercially known technology like DLP® (Digital Light Processing), or a “multijet modelling” such as commercially known technologies like “Stratasys Objet” and “3D Systems multijet”, or a technology used by the company Solidscape.

Such three-dimensional objects shall also be indicated, in the present description and in the following claims, as “three-dimensional models” or even simply as “models”. In particular, reference is made to the non-limiting case in which the three-dimensional objects are teeth, parts of teeth, elements of dental prostheses or the like.

A known three-dimensional 3D printer comprises a container in which is placed the fluid substance, generally a photosensitive resin in the liquid or paste state.

The machine further comprises a source, generally of the luminous type, which emits a radiation adapted to solidify the fluid substance (reference is also made to polymerisation of the photosensitive resin).

An optical unit conveys the aforesaid radiation towards a reference surface arranged inside the container, which corresponds to the position of the layer of the object to be solidified.

The three-dimensional object being formed is supported by a modelling base or plate, which is movable vertically with respect to the container so that the last solidified layer of the object can be arranged in a position adjacent to the aforesaid reference surface.

In this way, after each layer is solidified, the modelling base is moved so as to arrange the solidified layer again adjacent to the reference surface, whereupon the process can be repeated for the subsequent layer.

Typically, the three-dimensional object is fixed by means of anchoring elements to the modelling base, which is removable from the three-dimensional 3D printer, when the three-dimensional object is formed.

Before release the three-dimensional objects obtained from the modelling base, it is appropriate and necessary (especially in the dental sector) to remove the residues of fluid substance, typically the residues of photosensitive resin at the liquid or paste state, i.e. the non-solidified (non-polymerised) photosensitive resin.

To remove such residues, substantially two methodologies are known.

In the first methodology, a jet of compressed air is used, which however has the drawback that the surface of the three-dimensional object can be damaged.

In the second methodology, a bath of the three-dimensional object in an adequate solvent is used, typically in a tank filled with solvent. Such a methodology has the drawbacks of a significant consumption of solvent and of the need to wait a pre-set bathing time, which, however, does not always assure the desired complete removal of the residues.

The problem at the basis of the present invention is to provide a method for removing resin residues from a model obtained by three-dimensional 3D printing that overcomes the drawbacks described above, assuring better quality of removal and short removal times.

The present invention therefore, in a first aspect thereof, relates to a method for removing resin residues from a model created by three-dimensional 3D printing, the method including:
creating a three-dimensional model through three-dimensional 3D printing;
inserting the model into a container;
introducing a solvent into the container;
moving the container with the solvent and the model by means of repeated linear movements.

Therefore, according to the invention, a three-dimensional model, for example created by means of an appropriate resin that is polymerised in layers according to the prior art, is created in an appropriate three-dimensional 3D printer. Preferably, when the model is created it is fixed to a base, part of the three-dimensional 3D printer.

The model thus created is covered with resin that is still in the liquid or paste state, which has not been polymerised and which needs to be removed. The more the model comprises holes, recesses or otherwise has a relatively complex geometry, the more resin residues there will be.

The model, preferably together with the same base to which it is fixed, is inserted into a container. This container can be a separate element, or be a part of an apparatus.

Into the container is inserted an appropriate solvent, which depends on the type of resin that was polymerised. The solvent is selected because of its ability to remove the resin from the model.

The container is then moved by means of a plurality of linear movements. The movements can be imparted by hand, i.e. by a user who agitates the container manually, or it can be effected automatically by means of an apparatus, in particular when the container is a part of a more complex apparatus. Since the movements can also be performed by hand, a “linear movement” is to be understood as a movement whose linearity is the one obtainable with the precision available to a movement effected not only by a machine but also by a human operator. Therefore, the movement can involuntarily slightly deviate from perfect linearity, i.e. it might be slightly “curved”. Therefore with “linear” we mean in the present context a “as linear as possible” movement given the actuator of the movement, be it a human operator or a machine. Deviations from the linearity are therefore possibly present, but are preferably lower than the main direction of the movement in its entirety.

The choice between automatic or manual actuation depends, among other things, on the dimensions and on the weight of the model from which the remaining resin is to be removed.

The actuation includes a plurality of linear movements, i.e. movements along an axis. Not all the linear movements have to be along the same axis.

Preferably, the movement takes place along an axis included within an angle delimited by a vertical axis (Z axis in a system of coordinated axes) and an axis arranged at 45° with respect to the vertical axis. Preferably, for optimal cleaning, all linear movements are performed along a single axis positioned in the angle within the range from 0° to 45° (where 0° is the vertical axis), or along a plurality of axes always within the same angle.

Substantially, container undergoes “shaking”, enabling the solvent, which is introduced into the container and which by gravity resides on the bottom thereof, to wet the model and to slide thereon with a certain force due to the linear actuation.

The Applicant has found that this actuation and consequent bath of solvent in “jets” allows for optimal removal of the resin residues from the model.

The direction of movement along an axis within the preferred angle also exploits gravity for cleaning the model.

Advantageously, thanks to the provision of the container to be moved with repeated linear movements, an extensive removal of the resin residues from the model is obtained in a short time.

Moreover, the model is not damaged superficially, being subject to simple rinsing during the repeated linear moves of the container.

Furthermore, the solvent introduced into the container is markedly less than is provided in the prior art of bathing the three-dimensional object in the tank filled with solvent.

The preferred features of the method for removing resin residues from a model created by three-dimensional 3D printing according to the present invention, which can be provided individually or in combination with each other are described below.

Preferably, the step of introducing a solvent into the container includes introducing a solvent for not more than one third of an internal volume of the container. More preferably, the solvent fills between one fifth and one third of the internal volume of the container. The Applicant has found that this reduced quantity of solvent is sufficient to make possible an optimal removal of the resin residues from the model.

Preferably, said solvent includes alcohol.

Advantageously, it is a harmless, low-cost solvent.

Preferably, the step of creating a three-dimensional model through three-dimensional 3D printing includes creating a three-dimensional model by stereolithography, more preferably laser scanning stereolithography.

More preferably, the step of creating a three-dimensional model includes creating a three-dimensional model of a tooth or part thereof.

Advantageously, the stereolithography—and in particular the laser scanning stereolithography—is by now a well-known technology and it is particularly well suited to the dental sector.

Preferably, the method according to the invention includes the step of sealing said container before moving it.

Advantageously, in this way the solvent remains in the container even during the repeated linear movements thereof.

Preferably, said linear movements are carried out along one or more axes.

Preferably, the linear movements have an amplitude comprised between 0.5 and 1.5 times a height of the container.

More preferably, said repeated linear movements have an amplitude of at least 30 cm. For example, the amplitude is approximately 40 cm.

The amplitude is the distance between the end points of the linear movement, where the container stops before reversing its direction of movement.

More preferably, said repeated linear movements have a duration of between 30 seconds and 120 seconds.

Yet more preferably, said repeated linear movements have a frequency of at least 20 movements per minute. For example, the frequency is between 60 and 180 movements per minute, which in the case of reciprocating (forwards and backwards) linear movements corresponds to approximately to from 30 to 90 reciprocating movements (forwards and backwards) per minute.

Advantageously, the linear movements are simple to learn for the user who carries them out manually or are easily accomplished by means of an automatic actuation apparatus.

Linear movements within these frequency ranges allow a thorough cleaning while safeguarding the integrity of the model, in particular avoiding damage to its shape, or minimizing the risk of deformation, swelling or breakage. More in detail, linear movements as described reduce the risk of model breakages while maintaining speed and acceleration within certain parameters. Further, also the contact time between the model and solvent is preferably selected as described above (the contact time depends on the duration and frequency of the linear movements) since the deformations and the swelling of the models are related to the contact time between solvent and model. In any case, breakages, swellings and deformations are connected to each other because longer contact times imply more fragile models and their movements through “shacking” become more dangerous.

Preferably, the method according to the invention includes the step of making the model integral with the container before moving it.

Advantageously, the model is not damaged against inner walls of the container during the repeated linear movements imparted thereto.

In a second aspect thereof, the present invention relates to a container for removing resin residues from a model created by three-dimensional 3D printing, the container including:
a tank adapted to contain a solvent;
a cover adapted to close the tank, the cover including or being a base of three-dimensional 3D printer, the base including one or more anchoring elements for a three-dimensional model;
means for sealing the cover to the tank.

The container in accordance with the second aspect of the invention can be used to implement the method in accordance with the first aspect of the invention, and therefore it makes it possible to achieve all the advantages mentioned above.

The preferred features of the container for removing resin residues from a model created by three-dimensional 3D printing according to the present invention, which can be provided individually or in combination with each other are described below.

Preferably, the anchoring elements are directed towards the inside of the tank when the cover is fixed to the tank.

Advantageously, the model fixed to the anchoring elements is thus directed towards the inside of the tank.

Preferably, the cover includes an adapter adapted to sealingly receive the base of the three-dimensional 3D printer.

Advantageously, the adapter makes possible a rapid engagement/disengagement of the base of the three-dimensional 3D printer, bearing the model from which the resin residues are to be removed.

Preferably, the container according to the invention includes one or more handles, at least one of the handles comprising a duct having an inlet or an outlet outside of said tank and an outlet or an inlet inside of said tank, respectively for introducing or removing the solvent into or from the tank.

Advantageously, the handles allow a secure grip of the container, especially during the repeated linear movements imparted thereto. The duct is preferably and advantageously integrated in one of the handles

Further features and advantages of the invention will be more evident from the description of preferred embodiments thereof, made with reference to the accompanying drawings where:

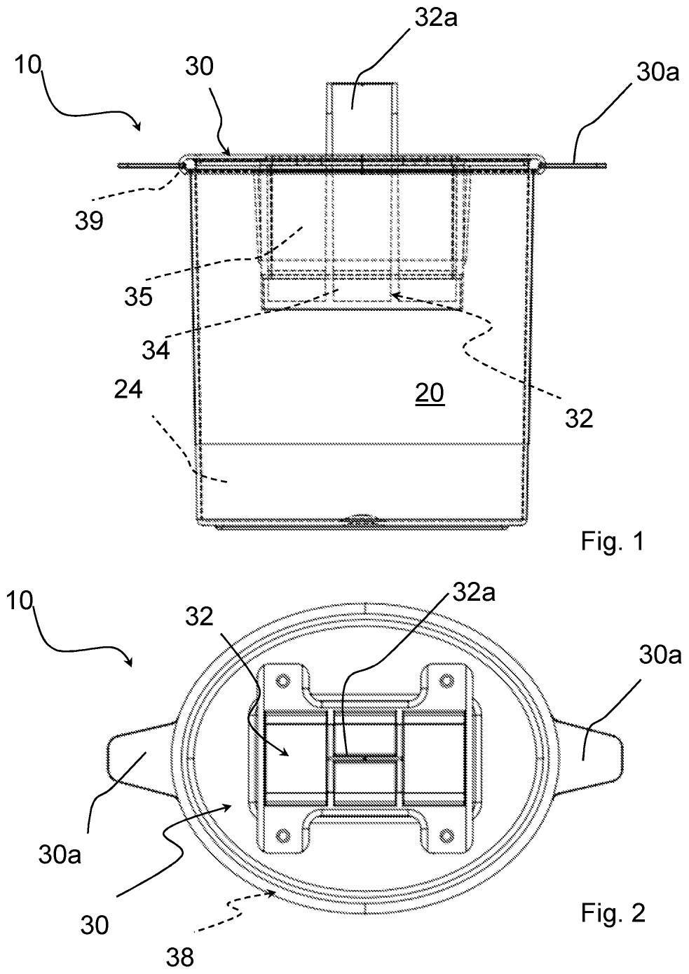

FIG. 1 is a lateral elevation view of a first embodiment of a container for removing resin residues from a model created by three-dimensional 3D printing according to the present invention;

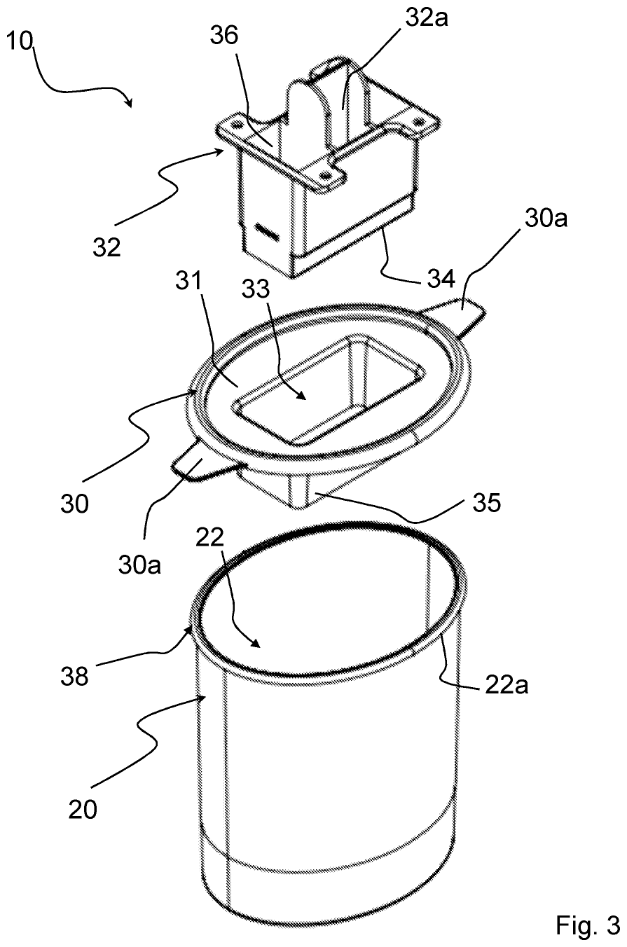

FIG. 2 is a top plan view of the container of FIG. 1;

FIG. 3 is an exploded perspective view of the container of FIG. 1;

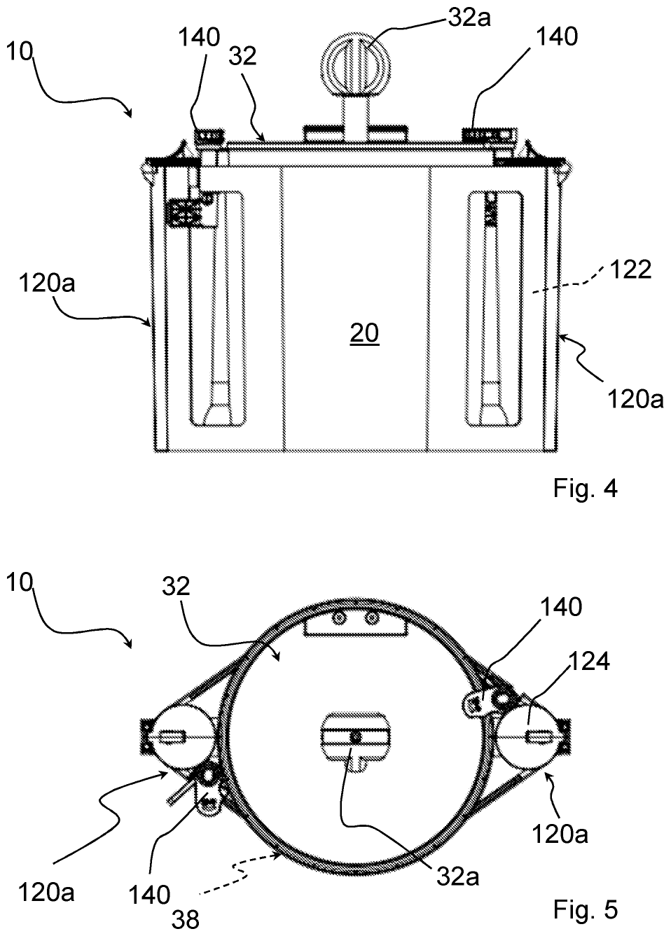

FIG. 4 is a lateral elevation view of a second embodiment of a container for removing resin residues from a model created by three-dimensional 3D printing according to the present invention;

FIG. 5 is a top plan view of the container of FIG. 4;

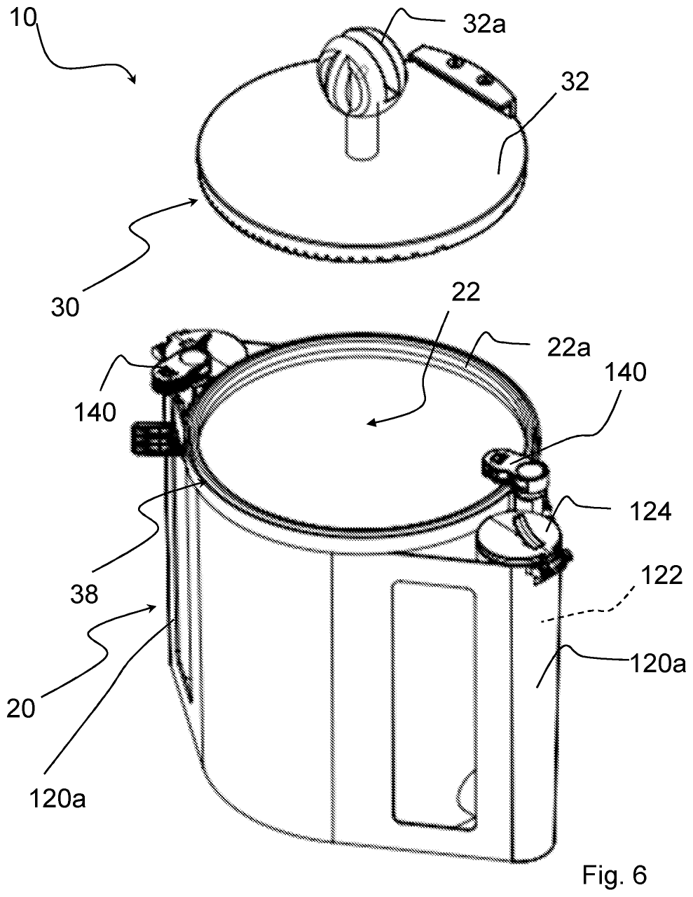

FIG. 6 is an exploded perspective view of the container of FIG. 4.

With initial reference to FIGS. 1-3, the numeral 10 indicates in its entirety a first embodiment of a container for removing resin residues from a model (not shown) created by three-dimensional 3D printing according to the present invention.

The container 10 includes a tank 20 and a cover 30, adapted to close an upper opening 22 of the tank 20.

The cover 30 includes a base 32 of three-dimensional 3D printer (not shown). Preferably the base 32 is a base of a stereolithographic machine, more preferably of the laser scanning type.

The base 32 bears the model formed in the three-dimensional 3D printer, which is anchored to the base 32 by means of an anchoring element 34.

The anchoring element 34 is extended from a substantially planar portion 36 of the base 32. In particular, the anchoring element 32 is directed towards the inside of the tank 20 when the cover 30 is fixed to the base 20 (FIG. 1). The anchoring element 34 has substantially cylindrical shape with substantially quadrilateral section, for example rectangular.

The tank 20 has substantially cylindrical shape with substantially elliptical base. Into the tank 20 is poured a solvent 24, for example alcohol, in particular ethyl alcohol.

Between cover 30 and tank 20 are provided sealing means 38, for example an annular gasket 39 positioned at an edge 22a of the upper opening 22 of the tank 20.

The cover 30 includes a substantially planar portion 31 on which is formed a through opening 33.

The cover 30 includes an adapter 35, adapted to sealingly receive the base 32.

The adapter 35 is extended from the substantially planar portion 31, at the through opening 33. In particular, the adapter 35 is directed towards the inside of the tank 20 when the cover 30 is fixed to the tank 20 (FIG. 1). The adapter 35 has substantially cylindrical shape and substantially quadrilateral section (for example rectangular) coupled to that of the anchoring element 34. The anchoring element 34 is insertable into the adapter 35 (FIG. 1).

A shape coupling is thus provided between anchoring element 34 and adapter 35.

To further facilitate the insertion and extraction of the anchoring element 34, the walls of the anchoring element 34 and of the adapter 35 can be slightly inclined, tapering in the direction towards the inside of the tank 20, when the cover 30 is fixed to the tank 20.

The cover 30 and the base 32 comprise respective grip appendages 30a and 32a.

A second embodiment of the invention is shown in FIGS. 4-6, in which elements that are structurally or functionally equivalent to those already described with reference to the first embodiment shown in FIGS. 1-3 are indicated with the same reference numeral.

In this second embodiment the cover 30 of the container 10 is substantially the base 32 of the three-dimensional 3D printer (not shown). Hence, the presence of an adapter 35 is not necessary, as is the case instead in the first embodiment of the invention.

The tank 20 has substantially cylindrical shape with substantially circular base.

Between base 32 and tank 20 are provided the sealing means 38. A pair of mutually opposite rotatable levers 140, mounted in proximity to the edge 22a of the upper opening 22 of the tank 20, locks/unlocks the base 32 to/from the tank.

The cover 30 comprises a grip appendage 30a.

The tank 20 includes two mutually opposite handles 120a, extending longitudinally with respect to the tank 20.

One of the handles 120a comprises a duct 122 having an inlet, closed by a removable plug 124, outside the tank 20 and an outlet or an inlet inside said tank 20, for introducing or removing the solvent 24 into or from the tank 20.

In operation, a method is implemented for removing resin residues from a model created by three-dimensional 3D printing, for example by stereolithography, in particular laser scanning stereolithography. The three-dimensional model can be a tooth or part thereof.

At first a three-dimensional model is created by three-dimensional 3D printing, then the base 32 of the three-dimensional 3D printer, bearing the model from which the resin residues are to be removed, is extracted.

The base 32 is associated to the cover 30 of the container 10 (first embodiment shown in FIGS. 1-3) or itself constitutes the cover 30 of the container 10 (second embodiment shown in FIGS. 4-6).

By means of the base 32, the model is inserted into a container 10. The base 32 is made integral to the tank 20 of the container 10, for which the model, too, is made integral with the container 10.

It is observed that in the case of the second embodiment shown in FIGS. 4-6, the tank 20 is preferably engaged to the base 32 when it is still in the three-dimensional 3D printer, so as to prevent the resin from dripping from the model to the exterior of the three-dimensional 3D printer and in the workplace.

The cover 30 and the tank 20 are sealed to each other by means of the sealing means 38.

Into the container 10 is introduced the solvent 24. Preferably, the solvent 24 does not fill more than one third of the internal volume of the container 10. More preferably, the solvent 24 does not fill more than one fifth of the internal volume of the container 10. Still more preferably, the solvent 24 fills approximately one tenth of the internal volume of the container 10. For example, a quantity of solvent 24 of between approximately 200 ml and approximately 300 ml can be used.

Then, the container 10 containing the solvent 24 and the model is moved by means of repeated linear movements.

Such linear movements are carried out along one or more axes. The actuation can be effected by hand, i.e. by a user who agitates the container 10 manually, or it can be effected automatically by means of an apparatus, in particular when the container 10 is a part of a more complex apparatus.

Preferably, the repeated linear movements have:
an amplitude of at least 30 cm (for example, the amplitude is equal to approximately 40 cm);
a duration of at least 3 minutes (for example, the duration is approximately 4 minutes);
a frequency of at least 20 movements per minute (for example, the frequency is approximately 30 movements per minute).

The elements comprising the container 10, i.e. the tank 20 and the cover 30 are reusable and the base 32 is reusable as well.

Obviously, a person skilled in the art, to meet specific and contingent requirements, may make numerous modifications and variants to the method and container for removing resin residues from a model created by three-dimensional 3D printing according to the present invention, without thereby departing from the scope of protection defined from the following claims.

1. Method for removing resin residues from a model created by three-dimensional 3D printing, the method comprising:
creating a three-dimensional model through three-dimensional 3D printing;
inserting the model into a container (10);
introducing a solvent (24) into the container (10);
moving the container (10) with the solvent (24) and the model by means of repeated linear movements.

2. The method according to claim 1, wherein introducing a solvent (24) into the container (10) includes introducing a solvent (24) for not more than one third of an internal volume of the container (10).

3. The method according to claim 1, wherein said solvent (24) includes alcohol.

4. The method according to claim 1, wherein creating a three-dimensional model through three-dimensional 3D printing includes creating a three-dimensional model by stereolithography, preferably or laser scanning stereolithography.

5. The method according to claim 1, wherein creating a three-dimensional model includes creating a three-dimensional model of a tooth or part thereof.

6. The method according to claim 1, further comprising sealing said container (10) before moving same.

7. The method according to claim 1, wherein said linear movements are carried out along at least one axis.

8. The Method according to claim 7, wherein said at least one axis is included within an angle defined between a vertical axis and an axis arranged at 45° from the vertical axis.

9. The method according to claim 1, wherein said repeated linear movements have an amplitude comprised between 0.5 and 1.5 times an height of the container.

10. The method according to claim 1, wherein said repeated linear movements have a duration of between 30 seconds and 120 seconds.

11. The method according to claim 1, wherein said repeated linear movements have a frequency of between 60 and 180 movements per minute.

12. The method according to claim 1, including making the model integral with the container (10) before moving the container.

13. Container (10) for removing resin residues from a model created through three-dimensional 3D printing, the container (10) comprising:
a tank (20) adapted to contain a solvent (24);
a cover (30) adapted to close the tank (20), the cover (30) including or being a base (32) of three-dimensional 3D printer, the base (32) including at least one anchoring element(34) for a three-dimensional model;
means (38) for sealing the cover (30) to the tank (20);
at least one handle (120a), comprising a duct (122) having an inlet or an outlet outside of said tank (20) and an outlet or an inlet inside of said tank (20), for introducing a solvent (24) or removing the solvent (24) from the tank (20) respectively.

14. The container (10) according to claim 13, wherein the at least one anchoring element(34) is directed towards the inside of the tank (20) when the cover (30) is fixed to the tank (20).

15. The container (10) according to claim 13, wherein the cover (30) includes an adapter (35) adapted to sealingly receive the base (32) of three-dimensional 3D printer.
